(19) United States
(12) Patent Application Publication
(10) Pub. No.: US 2011/0017408 A1
(43) Pub. Date: Jan. 27, 2011

(54) Venetian Blinds With Magnetic Controller For Regulation

(76) Inventor: Zoran Maksan, Biograd na Moru (HR)

Correspondence Address: ST. ONGE STEWARD JOHNSTON & REENS, LLC, 986 BEDFORD STREET, STAMFORD, CT, 06905-5619, US

(21) Appl. No.: 12/896,480

(22) Filed: Oct. 1, 2010

Related U.S. Application Data
(63) Continuation of application No. PCT/HR2009/000011, filed on Mar. 26, 2009.

(30) Foreign Application Priority Data
Apr. 1, 2008 (HR) P20080149A

(51) Int. Cl. E06B 9/303; E06B 9/32

(52) U.S. Cl. 160/168.1 R

(57) ABSTRACT

Magnetically actuated Venetian blinds may be positioned within a sealed double pane window. The blinds can be rotated or tilted, and lifted and lowered, by external battens. The blinds hang on a freely rotating bearing hollow pipe. Magnets on the bearing hollow pipe are magnetically engaged by magnets on an external regulating top batten. Gliding magnets along the batten engage magnets at the edges of the freely rotating bearing hollow pipe to rotate the slats through 180° of movement. One or both of the external regulating battens may be used to move the Venetian blind up or down by engagement of the batten magnets with the bottom section magnets. The Venetian blind may be positioned to shade any part of the window.

### CROSS-REFERENCE TO RELATED APPLICATIONS

The present application is a Continuation of pending International Patent Application No. PCT/HR2009/000011 filed on Mar. 26, 2009, which designates the United States and claims priority of Croatian Patent Application No. P20080149A filed on Apr. 1, 2008. The content of all prior applications is incorporated herein by reference.

### FIELD OF THE INVENTION

This invention refers to the Venetian blinds that are found in a dosed space between two window panes, and which are regulated by magnets from the outside. The invention is classified as E06B9/24 according to the international classification (IPC).

### BACKGROUND OF THE INVENTION

Problems that appear in the use of classic Venetian blinds are: a relatively complicated mechanism for their regulation, a decreased lifetime because of the exposure to all influences, complicated cleaning, impossibility to take the entire Venetian blinds down, bad thermal and sound insulation and a necessary assembly for the end user. AH mentioned technical problems are solved with external bottom and top battens with magnets that help Venetian blinds: rotate for 180° around the longer axis with horizontally regulating magnet, lift and lower with the external top/bottom batten, and move diagonally. In continuation, one of the technical solution consequences for the concerned invention is a completely changed way of Venetian blinds rotation. It is accomplished in a way that a freely rotating hollow bearing pipe rotates around the longitudinal axis, and the pipe diameter is approximately the same as the Venetian blind slat width or the space between window panes. One way to realize the invention is to rotate the pipe by horizontal movement or gliding of horizontally regulating magnet along the external top batten which produces attraction between magnets spirally fitted along the axis of the freely rotating bearing pipe, so in this way the linear movement transforms into rotation of the bearing pipe, that is, the whole Venetian blinds,

There were many attempts to solve some of the above-mentioned problems, but none of them succeeded to solve all mentioned flaws in a simple and financially acceptable way. It is not possible to take down whole Venetian blinds nor to set them up diagonally. None of the solutions for the regulation of Venetian blinds through magnets does not solve the lifting of a larger surface of Venetian blinds. A motor-operated regulation of Venetian blinds between window panes is expensive, unreliable and requires electric energy consumption. Offered mechanisms are far more mechanically complicated in relation to the invention presented here.

Technically, the solution presented by this invention has the following advantages in relation to other existing solutions:
unnecessary cleaning of Venetian blinds
easy set up
Venetian blinds durability has increased several times because of hermetically isolated space between insulation glass,
improved sound and thermal insulation of window
improved aesthetics of classic Venetian blinds (unnecessary strings and regulation bars)
possible Venetian blind positions that were before impracticable; diagonally setting and taking down of Venetian blinds
a completely new concept of rotation of Venetian blinds between window panes in relation to the solutions present on the market.

### SUMMARY OF THE INVENTION

The core of the invention is that the space between the window panes could be completely sealed from the environment, after the Venetian blinds regulated by magnets have been installed. Magnets are placed between window panes in the freely rotating bearing hollow pipe and in the bottom bearing batten together with the Venetian blinds and related strings, that is ladder which hold the individual slats or strips of the Venetian blind.

After installing the inner part of the Venetian blind, the space between the window panes is permanently sealed from the environment. Such insulation glass is placed in a window or door. All that is necessary for using and regulating the Venetian blinds are the bottom and top external batten, which enable the Venetian blind to be: rotated for 180° around the longer axis with horizontally regulating magnet, lifted and lowered with the external top/bottom batten, and moved diagonally.

One of the characteristics of the invention is a completely changed way of Venetian blinds rotation. It is accomplished in a way that a freely rotating hollow bearing pipe rotates around the longer axes, and the pipe diameter is approximately the same as the Venetian blind slat width or the space between window panes. One way to realize the invention is to rotate the pipe by horizontal movement or gliding of horizontally regulating magnet along the external top batten which produces attraction between magnets spirally fitted along the axis of the freely rotating bearing pipe, so in this way the linear movement transforms into rotation of the bearing pipe, that is, the whole Venetian blinds. The whole bearing rotating pipe is held in the desired position, which depends on the height of the top external rail of the bearing with the related magnets.

In the second alternative, the invention is accomplished with the horizontal gliding of external magnets along the top external rail to start the related magnets of the rotating bearing pipe. These inner magnets are mechanically connected with the spiral slot, that is with the slit along the part of the pipe. The slot holds approximately 180 degrees. In this way, the use of relatively complicated mechanisms for regulating Venetian blinds is avoided.

### BRIEF DESCRIPTION OF THE DRAWINGS

Hereafter follows a detailed description of the invention with reference to drawings, where:

FIG. 1 shows a frontal look to the window with the installed Venetian blind,

FIG. 2 is a perspective drawing of the Venetian blind with the freely rotating bearing pipe and the external top batten with magnets,

FIG. 3 shows the inner top contact magnets 8a and 8b according to the two modes of invention,

FIG. 4 shows two ways of realization of the freely rotating hearing pipe 4, with the slot 22, and with the spirally fitted magnets inside the rotating bearing pipe 4,

FIG. 5 is a perspective drawing of the rotating bearing pipe 4 and top external regulating batten 5 according to one mode of invention,

FIG. 6 shows the back view of the top external regulating batten 5, and

FIG. 7 is a perspective drawing of the bottom inner edge batten and bottom external regulating batten.

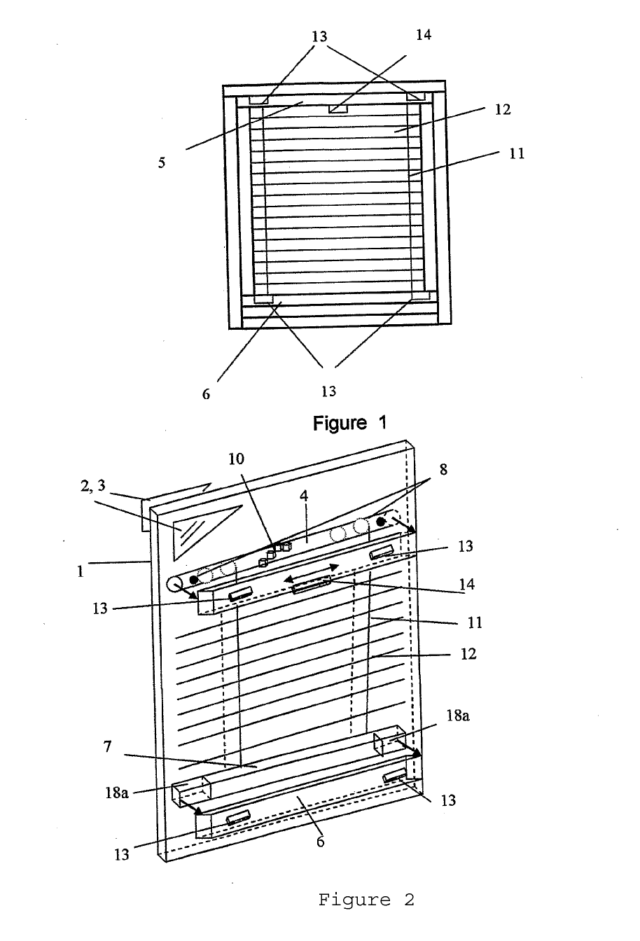

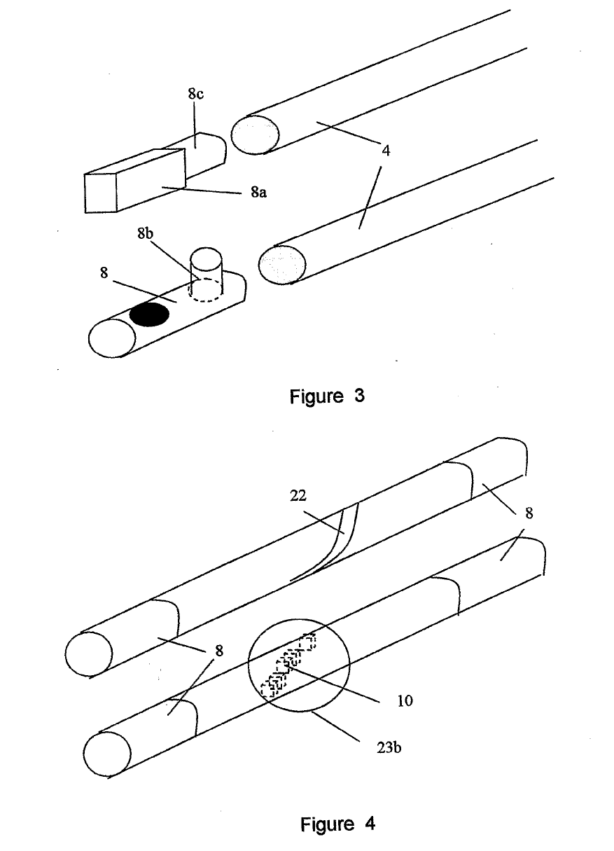

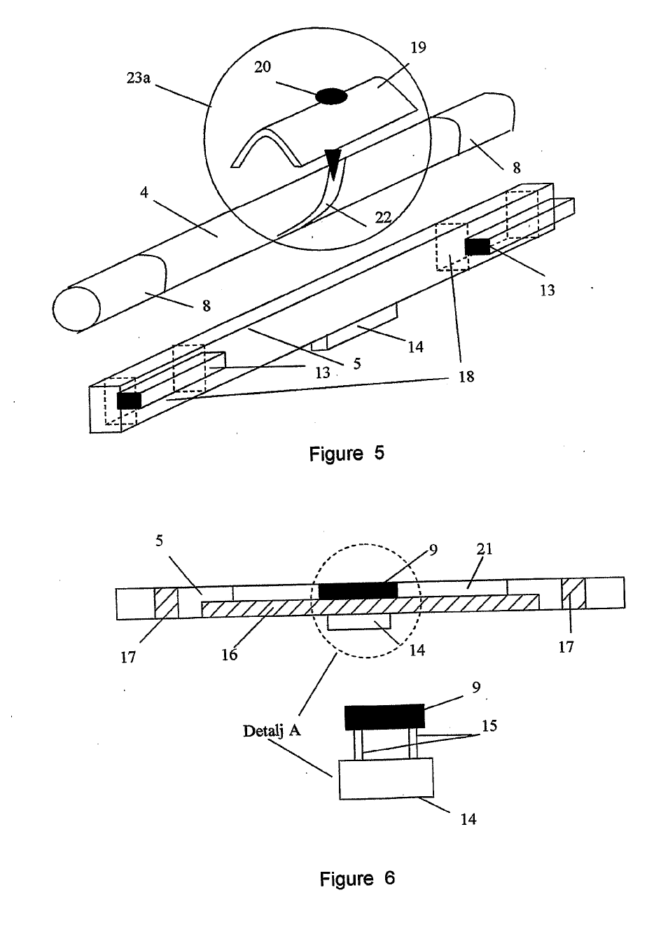

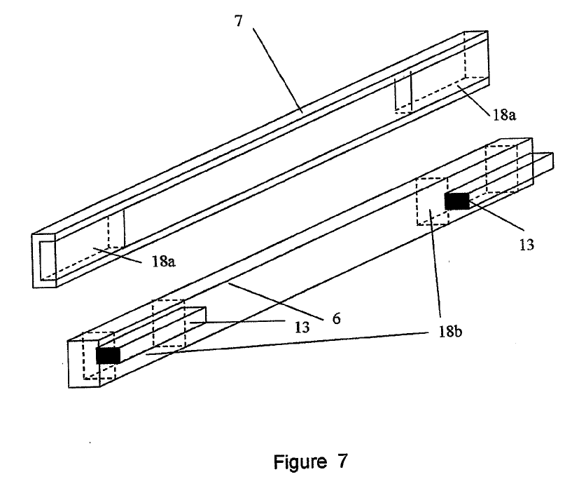

### DETAILED DESCRIPTION OF THE INVENTION

The invention shown on drawings 1 to 7 consists of strings which form ladder (11) which hold the horizontally fitted slats (12) at the appropriate distance. This structure hangs on the freely rotating bearing hollow pipe (4), and at the bottom it is connected to the inner bottom section (7). Each magnet (8b) in the bearings (8) or the inner top/bottom contact magnets (8a; 18 a) are fitted to be in the opposite magnet pole in relation to the poles of the external top/bottom contact magnets (18; 18b) on the external top and bottom regulating batten (5; 6) Magnets which glide horizontally along the external top regulating batten (5) attract magnets fitted at the edges of the freely rotating bearing hollow pipe (4). The rotation controller (23a; 23b) enables rotation of the slats (12) for 180°. By moving the bottomΛop. external regulating batten (6; 5) together with the related magnets it is possible to move the Venetian blind up or down, including moving of only one side of the top/bottom regulating batten (5; 6). Therefore, interaction of the mentioned elements of the invention it is possible to shade any part of the window, including shading diagonally along the window, which will be described in detail later.

Venetian blinds with the magnetic regulating controller, which may be fitted between two window panes (2, 3) or may be fitted on the outside of at least one window pane (2 or 3). Venetian blinds consist of slats (12), which are interconnected by ladders (11). Ladders (11) are connected to the freely rotating bearing hollow pipe (4), and on each end there are bearings (8) with at least one inner top contact magnet (8b), or according to the second mode of invention the bearing (8) makes the inner top contact magnet (8a). The freely rotating bearing hollow pipe (4) and bearing (8) or the inner top contact magnets (8a) are inserted in the rotating bearing hollow pipe (4) by the circular extension (8c) so that they fit in a way to enable the free rotation of the freely rotating bearing pipe in relation to the bearing (8) or the inner top contact magnet (8a). According to one mode of invention, the freely rotating bearing hollow pipe (4) comprises a spirally shaped slot (22) that lies symmetrically along half the surface of the freely rotating bearing pipe (4), in which the pin is inserted (20). The pin (20) is fixed to the inner central regulating magnet (19). According to the second mode of invention, the freely rotating bearing hollow pipe (4) in its middle part comprises spirally fitted permanent magnets (10), which enable rotation of the freely rotating bearing pipe (4), and thus the rotation of the slats by the effect of the rectilinear horizontal movement of the horizontal regulating magnet (9) on the spirally fitted inner permanent magnets (10).

Inside the top external regulating batten (5) there are laterally fitted external top contact magnets (18) with the poles oriented opposite in relation to the magnet poles (8a, 8b). Also, the top external regulating batten (5) laterally comprises gliding surfaces (17), and a strip (16) which extends over the slot (21) in a way to hold the horizontally regulating magnet (9) and thus enabling its unobstructed rectilinear horizontal movement inside the slot (21). The rotating bearing pipe (4) and the top regulating batten (5) are interconnected because of the mentioned magnets in a way that the freely rotating bearing pipe (4) follows the movements of the top regulating batten (5) and in this way enables the lifting/lowering, or leaning of the blinds at any desired angle. Inside the slot (21) on the batten (5) a horizontally regulating magnet (9) is fitted. With its rectilinear horizontal movement inside the slot (21), using the rotation controller (23a, 23b) it enables rotation of the slats.

Horizontally regulating magnet (9) is fixed by a device (15) to the horizontally movable handle (14) which is used to regulate the rectilinear horizontal movement of the magnets (9), and thus achieving the rotation of the slats. Inside the bottom external regulating batten (6) there are magnets (18b) with the poles oriented opposite in relation to the poles of the inner bottom contact magnets (18a) fitted in the bottom section (7). Therefore, the bottom external regulating batten (6) and bottom section (7) are interconnected because of the effects of magnets (18a, 18b) in a way that the bottom section (7) follows the movements of the bottom external regulating batten (6) and in this way enables the lifting/lowering, or leaning of the blinds at any desired angle.

Furthermore, the top and bottom regulating batten (5; 7) laterally comprise handles (13) for regulating the blinds, or lifting, lowering or diagonal movement of the blinds, while the central horizontally movable handles (14) enables rotation of the slats around the horizontal axis by 180°.

The mode of invention is to fit the blinds between the window panes before the space between them is sealed or partially closed. The blinds are regulated by magnets, composed of strings that form ladders together with the horizontally fitted slats or battens, rotating bearing pipe, bearings, inner bottom batten and spirally fitted magnets in the bearing pipe.

The window panes are then fitted in the appropriate window or door, and the external top and bottom regulating rail is fitted on the outside. They enable the whole blinds to be moved up and down, rotated around their axis in any of those positions, and placed diagonally.

The invention, as conceived, may be used to fit the blinds between the window panes or on the outside or the inside of the window or door.

What is claimed is:

1. Blinds with the magnetic controller for regulation, which may be fitted between two window panes or on the outside of at least one window pane, which comprise slats interconnected by ladders, comprising:
freely rotating bearing hollow pipe, which connect the ladders, and on each end there are bearings with at least one inner top contact magnet, or the inner top contact magnet,
top external regulating batten fitted with permanent magnets with poles oriented opposite in relation to the magnet poles so the rotating bearing pipe and the top regulating batten are interconnected because of the effects of magnets in a way that the freely rotating bearing pipe follows the movements of the top regulating batten and thus enabling lifting/lowering, or leaning of the blinds at any desired angle,
bottom external regulating batten fitted with permanent magnets with poles oriented opposite in relation to the poles of the inner bottom contact magnets fitted in the bottom section so the bottom external regulating batten and bottom section are interconnected because of the effects of permanent magnets in a way that the bottom section follows the movement of the bottom external regulating batten and thus enabling lifting/lowering, or leaning of the blinds at any desired angle,
Inside the slot on the batten a horizontally regulating magnet is fitted, which with its rectilinear horizontal movement inside the slot, using the rotation controller enables rotation of the slats.

2. The blinds according to claim 1, characterized in that the freely rotating bearing hollow pipe and bearing or the inner top contact magnet are mutually fitted to enable the free rotation of the freely rotating bearing pipe in relation to the bearing or the inner top contact magnet.

3. The blinds according to claim 2, characterized in that the freely rotating bearing hollow pipe additionally comprises a spirally shaped slot that lies symmetrically along half the surface of the freely rotating bearing pipe in which the pin is inserted, and which is fixed to the horizontally regulating magnet.

4. The blinds according to claim 2, characterized in that the freely rotating bearing hollow pipe in its middle part contains spirally fitted permanent magnets, which enable rotation of the freely rotating bearing pipe, and thus the rotation of the slats by the effect of the rectilinear horizontal movement of the horizontal regulating magnet on the spirally fitted inner permanent magnets.

5. The blinds according to claim 2, characterized in that the inner top contact magnets are inserted in the rotating bearing hollow pipe by the circular extension.

6. The blinds according to claim 2, characterized in that the rotating bearing hollow pipe is inserted in the bearing.

7. The blinds according to claim 1, characterized in that the top external regulating batten laterally comprises external top contact magnets, gliding surfaces, and a strip which extends over the slot in a way to hold the horizontally regulating magnet and thus enabling its unobstructed rectilinear horizontal movement inside the slot.

8. The blinds according to claim 1, characterized in that the horizontally regulating magnet is fixed by a device to the horizontally movable handle which is used to regulate the rectilinear horizontal movement of the magnets, and thus achieving the rotation of the slats.

9. The blinds according to claim 1, characterized in that the top and the bottom regulating batten laterally comprise handles for regulating the blinds.
